(19) United States
(12) Patent Application Publication
(10) Pub. No.: US 2013/0256226 A1
(43) Pub. Date: Oct. 3, 2013

(54) METHOD AND APPARATUS FOR TREATING ORGANIC WASTEWATER

(71) Applicant: Yu Tanaka, Tokyo (JP)

(72) Inventor: Yu Tanaka, Tokyo (JP)

(73) Assignee: KURITA WATER INDUSTRIES LTD, Tokyo (JP)

(21) Appl. No.: 13/991,552

(22) PCT Filed: Dec. 16, 2011
(86) PCT No.: PCT/JP2011/079164

§ 371 Date: Jun. 4, 2013

(30) Foreign Application Priority Data
Jan. 5, 2011 (JP) 2011-000600

(51) Int. Cl. C02F 9/00

(52) U.S. Cl. CPC C02F 9/00
USPC 210/631; 210/636; 210/202

(57) ABSTRACT

[Object] In relation to the treatment of organic wastewater in which organic wastewater is separated from biosludge by solid liquid separation using a separation membrane and the permeate water is subjected to RO membrane separation treatment and further in which normal solid liquid separation treatment is suspended and the membrane is cleaned by passing a cleaning liquid through the membrane from the permeate water side to the concentrated water side, the invention prevents a decrease in the flux of RO membranes due to TOC components eluted from the sludge during membrane cleaning and thereby reduces the frequency of chemical cleaning of the RO membranes as well as increases water recovery rate, thus allowing the treatment to be performed stably and efficiently.

[Solution] After membrane cleaning, the solid liquid separation is resumed in such a manner that the pH of the obtainable permeate water is adjusted to not less than 9.5 and a scale inhibitor is added to the permeate water, and the permeate water is thereafter treated by RO membrane separation treatment. By adjusting the pH of the RO feed water to a highly alkaline pH of not less than 9.5 as well as by adding a scale inhibitor, it becomes possible to suppress TOC components eluted from sludge from being adsorbed onto RO membranes and from generating slimes as well as consequently to prevent a decrease in the flux of RO membranes.

### FIELD OF INVENTION

The present invention relates to a method and an apparatus for treating organic wastewater, in particular to a method and an apparatus for treating organic wastewater that is suitably applied to water recovery and a reuse system in which ultrapure water that has been used and become contaminated during a processes for manufacturing electronic components such as semiconductors and silicon wafers is biologically treated and further treated by reverse osmosis (RO) membrane separation to produce raw water for ultrapure water.

### BACKGROUND OF INVENTION

Ultrapure water is used in processes for manufacturing electronic components such as semiconductors and silicon wafers. After ultrapure water is used, wastewater is recovered and treated in a system to produce raw water for ultrapure water. In such a system, wastewater is biologically treated to decompose and remove organic matters present therein and is further treated by reverse osmosis (RO) membrane separation to remove residual organic matters as well as to demineralize the water. The RO permeate water is reused as raw water for ultrapure water.

The biological treatment carried out before the RO membrane separation treatment often utilizes a membrane bioreactor (MBR) in which contaminated water is biologically treated and separated into solids and liquids with separation membranes.

MBRs have a submerged MBR configuration in which solid liquid separation is carried out with separation membranes immersed in a biological reactor (for example, Patent Document 1 and Non Patent Document 1), and an external MBR configuration in which sludge is supplied to a membrane separation apparatus separate from a biological reactor and the concentrated water resulting from solid liquid separation through the membranes is returned to the biological reactor (for example, Patent Document 2). Both of these configurations enable efficient biological treatments by keeping sludge with high concentration in the system. The separation membranes become blocked during continuation of the treatment and thus need to be cleaned with chemicals regularly or as required.

As described in a prior art section in Patent Document 1, immersed membranes used in submerged MBR systems are conventionally transferred to and cleaned in a separate cleaning container or are conventionally cleaned by replacing the sludge in the membrane immersion tank with a cleaning liquid. These approaches reflect adverse effects on biological treatments such as microorganisms being possibly killed by prolonged impregnation of the sludge with a cleaning liquid. The above approaches not only require much labor and time for operation but also have problems in that the use of large amounts of cleaning liquids increases costs and results in the generation of large volumes of cleaning waste liquids.

Membranes in external MBR systems are conventionally cleaned by providing circulation lines exclusive for membrane cleaning separate from circulation lines between the separation membranes and the biological reactor to avoid any contamination of cleaning liquids into the biological reactor. This approach does not require complicated works such as transferring of the separation membranes and replacement of the sludge in contrast to the cleaning approaches in submerged MBR systems. In this approach, cleaning circulation lines are separately provided. Thus, costs are increased due to the need of extra facilities such as cleaning tanks, pumps and water pipes. Further, this approach entails certain amounts of cleaning liquids enough to perform circulation cleaning, and treatments of the cleaning waste liquids add costs.

With such problems, there has recently been a shift away from conventional cleaning methods in submerged MBR systems which involve transferring of immersed membranes to a cleaning container or replacement of sludge as described in Patent Document 1 and Non Patent Document 1. Instead, a more frequent cleaning method is such that while normal solid liquid separation treatment is suspended, a cleaning liquid is passed through the separation membranes immersed in the biological reactor from the permeate water side to the concentrated water side, namely, in a reverse direction to such an extent that the cleaning liquid is mixed into the sludge. This cleaning method is based on a knowledge that although microorganisms are killed if large amounts of oxidative cleaning liquids or acidic cleaning liquids are mixed into water being biologically treated, the growth of microorganisms is not adversely affected as long as the amounts of cleaning liquids are small and consumed in the biological reactor.

### LIST OF DOCUMENTS

Patent Document 1: Japanese Patent Publication 2000-500392 A

Patent Document 2: J Japanese Patent Publication 2009-148714 A

Non Patent Document 1: ENVIRONMENTAL CONSERVATION ENGINEERING, Vol. 28, No. 8, pp. 552-555 (1999), “MAKUBUNRI SOUCHI NO YAKUEKI SENJOU NI TOMONAU ODEI NO GENRYOU NI KANSURU KENKYUU (STUDY ON REDUCTION OF SLUDGE ASSOCIATED WITH CLEANING OF MEMBRANE SEPARATION APPARATUS WITH CHEMICAL LIQUIDS)”

### OBJECT AND SUMMARY OF INVENTION

When the above cleaning method is adopted in submerged MBR systems, TOC components are eluted from sludge due to influences of cleaning liquids. This elution causes problems in the subsequent recovery of water using an RO membrane separation apparatus. That is, after the normal treatment is resumed after the membranes are cleaned, TOC components which have been eluted from the sludge during cleaning and have found their way into the permeate water side become adsorbed onto the RO membranes or generate slimes in the RO membrane separation apparatus. As a result, the permeation rate (flux) of RO membranes is lowered, requiring frequent cleaning of the RO membranes.

A conventional remedy to this is that after the membrane cleaning, the operation is resumed in such a manner that permeate water is discharged from the system or returned to the raw water tank without being introduced into the RO membrane separation apparatus until TOC components eluted from the sludge come to be absent from the permeate water. However, this drastically lowers treatment efficiency and water recovery rate.

The present invention solves these problems in the art. In relation to the treatment of organic wastewater in which water permeated through MBR membranes (hereinafter, sometimes referred to as “MBR permeate water”) is subjected to RO membrane separation treatment and further in which normal solid liquid separation treatment is suspended and the membranes are cleaned by passing a cleaning liquid through the membranes from the permeate water side to the concentrated water side, it is an object of the invention to provide methods and apparatuses for treating organic wastewater which can prevent a decrease in the flux of RO membranes due to TOC components eluted from the sludge during membrane cleaning and thereby can reduce the frequency of chemical cleaning of the RO membranes as well as can increase water recovery rate, thus allowing the treatment to be performed stably and efficiently over a long time.

The present inventor carried out extensive studies in order to solve the aforementioned problems. As a result, the present inventor has found that it becomes possible to suppress TOC components eluted from sludge from being adsorbed onto RO membranes and from generating slimes as well as consequently to prevent a decrease in the flux of RO membranes by adjusting the pH of MBR permeate water to be supplied to an RO membrane separation apparatus (hereinafter, the MBR permeate water to be supplied to an RO membrane separation apparatus will be sometimes referred to as “RO feed water”) to a highly alkaline pH of not less than 9.5 as well as by adding a scale inhibitor.

The present invention has been completed based on the above findings. A summary of the invention is as follows.

A first aspect is directed to a method for treating organic wastewater in which organic wastewater is biologically treated and separated from biosludge by solid liquid separation using a separation membrane, and the permeate water is subjected to reverse osmosis membrane separation treatment, the method including a solid liquid separation step of separating the biosludge by solid liquid separation with a separation membrane, and a cleaning step of suspending the passage of water through the separation membrane to filter the biosludge and passing a membrane cleaning liquid through the separation membrane from the permeate water side to the concentrated water side to clean the separation membrane, the cleaning step being followed by the resumption of the solid liquid separation step in such a manner that the pH of the obtainable permeate water is adjusted to not less than 9.5 and a scale inhibitor is added to the permeate water, and the permeate water is thereafter treated by the reverse osmosis membrane separation treatment.

A second aspect is directed to the method for treating organic wastewater of the first aspect, wherein the membrane cleaning liquid includes an oxidative cleaning agent and/or an acidic cleaning agent.

A third aspect is directed to the method for treating organic wastewater of the first or second aspect, wherein the separation membrane is a submerged membrane immersed in a biological reactor.

A fourth aspect is directed to an apparatus for treating organic wastewater including a biological treatment unit which biologically treats organic wastewater, a membrane separation unit which separates biosludge in the biological treatment unit by solid liquid separation with a separation membrane, a reverse osmosis membrane separation unit which treats permeate water from the membrane separation unit by reverse osmosis membrane separation treatment, a cleaning unit which cleans the separation membrane by passing a membrane cleaning liquid through the separation membrane of the membrane separation unit from the permeate water side to the concentrated water side, a pH adjustment unit which adjusts the permeate water from the membrane separation unit that is to be introduced into the reverse osmosis membrane separation unit to a pH of not less than 9.5, and a scale inhibitor addition unit which adds a scale inhibitor to the permeate water.

A fifth aspect is directed to the apparatus for treating organic wastewater of the fourth aspect, wherein the membrane cleaning liquid includes an oxidative cleaning agent and/or an acidic cleaning agent.

A sixth aspect is directed to the apparatus for treating organic wastewater of the fourth or fifth aspect, wherein the separation membrane is a submerged membrane immersed in a biological reactor.

### Advantageous Effects of Invention

In the treatment of organic wastewater in which organic wastewater is treated by an MBR system and the permeate water is subjected to RO membrane separation treatment and further in which normal solid liquid separation treatment is suspended and the membranes are cleaned by passing a cleaning liquid through the membranes from the permeate water side to the concentrated water side and thereafter the solid liquid separation treatment is resumed, the present invention can prevent a decrease in the flux of RO membranes due to TOC components eluted from the sludge during membrane cleaning and thereby can reduce the frequency of chemical cleaning of the RO membranes as well as can increase water recovery rate, thus allowing the treatment to be performed stably and efficiently over a long time.

In the present invention, the MBR permeate water that is RO feed water is adjusted to a pH of not less than 9.5. This control provides the following effects i) and ii).

i) TOC components eluted from sludge cause a decrease in RO membrane flux. These components are unlikely to become adsorbed to membrane surfaces under alkaline conditions. By controlling the pH of an MBR permeate water that is an RO feed water to 9.5 or above, the attachment of these components to RO membrane surfaces can be suppressed.

ii) Microorganisms cannot live under alkaline conditions. Thus, adjusting an MBR permeate water to a pH of not less than 9.5 can render the environment in an RO membrane separation apparatus nutritious but lethal to microorganisms. Consequently, it becomes possible to suppress the formation of slimes in the RO membrane separation apparatus.

A scale inhibitor is added to the MBR permeate water that is RO feed water for the reasons described below.

Organic wastewater to be treated according to the present invention, for example, organic wastewater discharged from facilities such as electronics manufacturing plants, can contain scale-forming substances such as calcium ions in some rare cases. When an RO system is operated under high pH conditions with the pH of an RO feed water being 9.5 or above, even trace calcium ions form scales such as calcium carbonate and the RO membranes are blocked shortly afterward. In order to suppress the occurrence of blocked membranes due to scales, in the present invention, a scale inhibitor is added to an MBR permeate water that is an RO feed water and thereby the formation of scales is prevented.

### BRIEF DESCRIPTION OF DRAWINGS

FIG. 1 is a system diagram illustrating an embodiment of a method and an apparatus for treating organic wastewater according to the present invention.

FIG. 2 is a graph illustrating results obtained in Example 1 and Comparative Example 1.

### DESCRIPTION OF EMBODIMENTS

Hereinbelow, embodiments of methods and apparatuses for treating organic wastewater according to the invention will be described in detail with reference to the drawings.

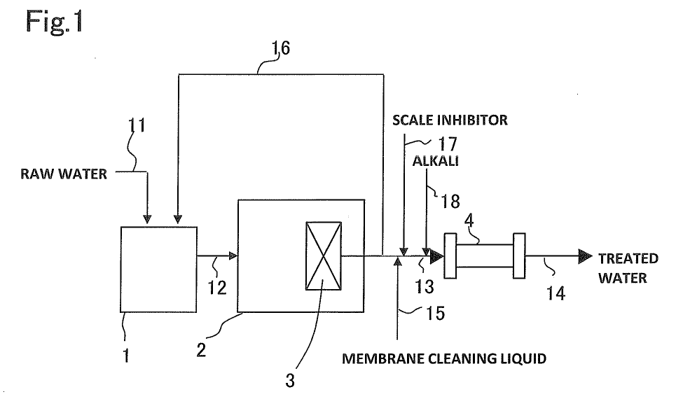

FIG. 1 is a system diagram illustrating an embodiment of a method and an apparatus for treating organic wastewater according to the present invention. In FIG. 1, the reference sign 1 indicates a raw water tank, 2 a biological reactor (biologically treating tank), 3 a separation membrane module immersed in the biological reactor 2, and 4 an RO membrane separation apparatus.

Raw water is introduced into the raw water tank 1 through a pipe 11 and further into the biological reactor 2 through a pipe 12, and is biologically treated in the reactor. The biosludge is separated by solid liquid separation through the separation membrane module 3. The permeate water is introduced into the RO membrane separation apparatus 4 through a pipe 13 and is subjected to RO membrane separation treatment. The RO permeate water is discharged as treated water from the system through a pipe 14.

When the separation membrane module 3 is to be cleaned, the introduction of the raw water into the biological reactor 2 as well as the collection of the permeate water from the separation membrane module 3 are suspended, and a membrane cleaning liquid is injected to the pipe 13 through a pipe 15 and is pushed in a reverse direction to the treatment, namely, from the permeate water side to the concentrated water side of the separation membrane module 3. The completion of the injection of a prescribed amount of the membrane cleaning liquid is followed by the resumption of the introduction of the raw water into the biological reactor 2 as well as the resumption of the solid liquid separation at the separation membrane module 3. In an early stage after the resumption of the treatment after the membrane cleaning, the MBR permeate water (the permeate water from the membrane module 3) contains oxidizers and acid components derived from the membrane cleaning liquid. Subjecting such permeate water to treatment in the RO membrane separation apparatus 4 increases loads on the RO membranes and causes damages of the RO membranes. Thus, the initial MBR permeate water is returned to the raw water tank 1 through a pipe 16 until oxidizers and acid components derived from the membrane cleaning liquid are reduced to an undetectable level or a sufficiently low level in the MBR permeate water, for example, until the residual chlorine concentration becomes 0 mg/L.

After the initial MBR permeate water is returned to the raw water tank 1 after the resumption of solid liquid separation in the above manner or after the oxidative power is neutralized with sodium bisulfite, the MBR permeate water is passed to the RO membrane separation apparatus 4. At this presumption, namely at the beginning of the solid liquid separation again, a scale inhibitor is added to the RO feed water pipe 13 through a pipe 17 while an alkali is added through a pipe 18. In this manner, the MBR permeate water to be introduced as the RO feed water into the RO membrane separation apparatus 4 is adjusted to a pH of not less than 9.5, and such permeate water is passed to the RO membrane separation apparatus 4. The alkali and the scale inhibitor may be added in any sequence or simultaneously to the MBR permeate water.

The addition of a scale inhibitor and the addition of an alkali to adjust the MBR permeate water to a pH of not less than 9.5 may take place only during a stage in which large amounts of TOC components (for example, not less than 5 mg of TOC/L) are detected in the MBR permeate water after the membrane cleaning of the separation membrane module 3. Alternatively, the addition of a scale inhibitor and the addition of an alkali for pH adjustment may take place during the entirety of the treatment period.

As described above, a scale inhibitor is added to the MBR permeate water that is an RO feed water and an alkali is added thereto in order to adjust the pH of the permeate water to not less than 9.5 at least during a stage in which the MBR permeate water contains high concentrations of TOC components after the resumption of RO membrane separation treatment after membrane cleaning. According to this configuration, a decrease in RO membrane flux can be prevented and the treatment can be carried out stably and efficiently over a long time.

Examples of the organic wastewater to be treated in the present invention include high to low concentration organic wastewater discharged in various industrial fields such as electronics manufacturing field and semiconductor manufacturing field. The present invention may be effectively applied to water treatments for releasing, or recovering and reusing such organic wastewater. In particular, the invention is suitably applied to systems in which ultrapure water that has been used and become contaminated during processes for the manufacturing of electronic components such as semiconductors and silicon wafers is recovered and reused as raw water for ultrapure water.

The MBR biological treatment may be an aerobic biological treatment or an anaerobic biological treatment. As already described, conventional submerged MBR apparatuses are unsuited for anaerobic biological treatments because the cleaning of membranes entails the need of transferring the separation membranes from the biological reactor (the membrane separation tank) to a separate cleaning container. In contrast, the present invention is free from the need of removing the separation membranes from the biological reactor, and the treatment can be carried out in an anaerobic atmosphere while maintaining a certain level of vacuum in the biological reactor. Thus, the present invention can be applied even to anaerobic biological treatments without problems.

The loads in the biological treatments are not particularly limited. The BOD load in an aerobic biological treatment is preferably 0.5 to 5.0 kg-BOD/m³/day, and desirably 0.5 to 2.0 kg-BOD/m³/day. The BOD load in an anaerobic biological treatment is preferably 1.0 to 10.0 kg-BOD/m³/day, and desirably 2.0 to 6.0 kg-BOD/m³/day.

Examples of the MBR separation membranes include microfiltration (MF) membranes, ultrafiltration (UF) membranes and nanofiltration (NF) membranes. Exemplary membrane configurations include flat membranes, tubular membranes and hollow filament membranes, but are not limited thereto. Examples of the membrane materials include, although not limited to, polyvinylidene fluoride (PVDF), polyethylene (PE) and polypropylene (PP).

A suitable membrane cleaning liquid contains an oxidative cleaning agent and/or an acidic cleaning agent. Oxidative cleaning agents are effective for cleaning organic contaminations. Acidic cleaning agents are effective for cleaning inorganic contaminations such as calcium or iron contaminants. Examples of the oxidative cleaning agents which may be used include sodium hypochlorite and hydrogen peroxide. Examples of the acidic cleaning agents which may be used include oxalic acid, citric acid, hydrochloric acid and sulfuric acid. In the presence of calcium contaminants, the use of sulfuric acid is not preferable because calcium scales are formed easily. Calcium components are sometimes substantially absent in contaminated ultrapure water. However, depending on production processes, calcium components can be found in wastewater, originating from, for example, the addition of nutrients in the biological treatment.

The oxidizer cleaning agents and the acidic cleaning agents may be used singly, or two or more may be used as a mixture. In membrane cleaning, these cleaning agent components may be usually used as an approximately 1 to 5 wt % aqueous solution in the case of oxalic acid or citric acid, and as an aqueous solution having a chlorine concentration of about 500 to 5000 mg-Cl/L in the case of sodium hypochlorite.

In membrane cleaning, the injection amount and the injection time for the membrane cleaning liquid are not particularly limited, and may be determined appropriately in accordance with, for example, the types of cleaning agents used and the degree of membrane contamination.

Suitable scale inhibitors added to the MBR permeate water after membrane cleaning are chelating scale inhibitors such as ethylene diamine tetraacetic acid (EDTA) and nitrilotriacetic acid (NTA) which are easily dissociated under alkaline conditions and form complexes with metal ions. Examples of other scale inhibitors which may be used include low-molecular weight polymers such as (meth)acrylic acid polymers, salts thereof, maleic acid polymers and salts thereof; phosphonic acid and phosphonic acid salts such as ethylene diamine tetramethylene phosphonic acid, salts thereof, hydroxyethylidene diphosphonic acid, salts thereof, nitrilotrimethylene phosphonic acid, salts thereof, phosphonobutane tricarboxylic acid and salts thereof; and inorganic phosphoric acid polymers and inorganic phosphoric acid polymer salts such as hexametaphosphoric acid, salts thereof, tripolyphosphoric acid and salts thereof. These scale inhibitors may be used singly, or two or more may be used in combination.

If the scale inhibitors are added in excessively small amounts, the inhibitors cannot fully prevent the adverse effects by scale-forming components at the RO membranes. Excessively large amounts are not preferable because of chemical costs. The scale inhibitors are preferably added with a concentration of about 1 to 500 mg/L, or in an amount approximately 5 to 50 times by weight the calcium ion concentration in the MBR permeate water, although variable depending on the concentration of scale-forming components in the MBR permeate water that is an RO feed water.

An alkali is added to the MBR permeate water that is an RO feed water so as to adjust the pH of the water to not less than 9.5, preferably not less than 10, and more preferably 10.5 to 12, for example, 10.5 to 11, and such permeate water is introduced into the RO membrane separation apparatus 4. The alkali agents used herein may be any inorganic alkali agents without limitation which can adjust the pH of the RO feed water to not less than 9.5, with examples including sodium hydroxide and potassium hydroxide.

Examples of the RO membranes in the RO membrane separation apparatus 4 include alkali resistant membranes such as polyether amide composite membranes, polyvinyl alcohol composite membranes and aromatic polyamide membranes. The RO membranes may have any configurations such as spiral, hollow filament and tubular configurations.

FIG. 1 illustrates an embodiment of the present invention, and the present invention is not limited to the illustrated embodiment and may be modified within the scope of the invention.

For example, while FIG. 1 illustrates a submerged MBR system, the present invention is effective not only in submerged MBR systems but also in external MBR systems for preventing a decrease in RO membrane flux at the resumption of treatment after membrane cleaning. Mixed types of submerged MBR systems may be utilized. That is, membranes may be immersed directly in a biological reactor; alternatively, a separate membrane immersion tank is provided to which biosludge from a biological reactor is introduced and subjected to solid liquid separation, the concentrated water filtered through the membranes being circulated to the biological reactor.

The treated water (the RO permeate water) obtained according to the present invention is usually adjusted to a pH of 4 to 8 by the addition of an acid, optionally subjected to further treatments such as active carbon treatment, and thereafter reused or released. The acids used herein are not particularly limited. Exemplary acids include mineral acids such as hydrochloric acid and sulfuric acid.

### EXAMPLES

The present invention will be described in greater detail by presenting Examples and Comparative Examples below.

### Example 1

Electronic industry wastewater (TOC: 80 to 100 mg/L) as raw water was aerobically treated with an MBR system (sludge concentration: 4,000 to 8,000 mg/L) under a load of 0.5 to 1.0 kg-BOD/m³/d using organic wastewater treatment apparatus illustrated in FIG. 1. The following separation membranes and RO membranes were used in an MBR biological reactor 2 and an RO membrane separation apparatus 4. During normal operation, the TOC concentration in the MBR permeate water (membrane permeate water) was 3 to 5 mg/L.

Separation membranes: PVDF submerged hollow filament UF membranes (manufactured by MITSUBISHI RAYON CO., LTD., membrane area 12 m²)

RO membranes: aromatic polyamide spiral RO membranes (manufactured by NITTO DENKO CORPORATION)

The membranes in the treatment apparatus were cleaned once a week in the following manner. While a separation membrane module 3 was kept immersed in the sludge in the biological reactor 2, 26 L of a 700 mg-Cl/L aqueous sodium hypochlorite solution as a membrane cleaning liquid was injected from the permeate water side to the concentrated water side over a period of 30 minutes.

Immediately after the membrane cleaning liquid was injected, residual chlorine would be detected in the MBR permeate water (membrane permeate water). Thus, the permeate water was not supplied to the RO membrane separation apparatus 4 and was instead returned to a raw water tank 1 for 1 hour after the membrane cleaning.

Thereafter, sodium hydroxide was added to the MBR permeate water (membrane permeate water: TOC 5 to 10 mg/L, pH 5.5) to adjust the pH to 10.5, and 30 ppm of a chelating scale inhibitor (“WELCLEAN A801” manufactured by Kurita Water Industries Ltd.) was added. Thereafter, the permeate water was passed to the RO membrane separation apparatus 4 (water recovery rate 85%).

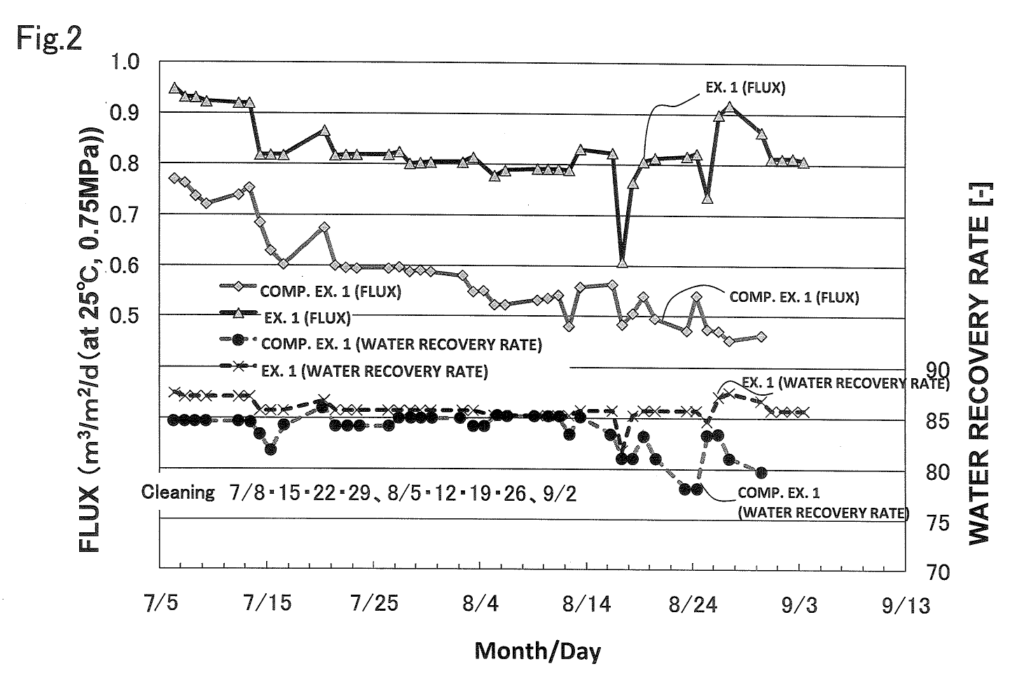

Changes in the RO membrane flux and the water recovery rate with time in the RO membrane separation apparatus 4 were examined, the results being illustrated in FIG. 2.

### Comparative Example 1

The treatment was carried out in the same manner as in EXAMPLE 1, except that sodium hydroxide and the scale inhibitor were not added to the MBR permeate water (pH 5.5) as well as that 3 ppm of an isothiazoline slime controlling agent (“KURIVERTER EC503” manufactured by Kurita Water Industries Ltd.) was added and the permeate water was passed to the RO membrane separation apparatus. Changes in the RO membrane flux and the water recovery rate with time in the RO membrane separation apparatus were examined, the results being illustrated in FIG. 2.

From FIG. 2, it has been illustrated that the RO membrane flux in COMPARATIVE EXAMPLE 1 decreased with time to below 0.5 m³/m²/d; in contrast, the RO membrane flux was stably maintained at about 0.8 m³/m²/d in EXAMPLE 1 in which the RO feed water had been adjusted to an alkaline pH and combined with the scale inhibitor.

### INDUSTRIAL APPLICABILITY

The present invention is effectively applied to water treatments for releasing, or recovering and reusing high to low concentration organic wastewater discharged in various industrial fields such as electronics manufacturing field and semiconductor manufacturing field.

Although the present invention has been described in detail with respect to some specific embodiments, the skilled person will appreciate that various modifications are possible within the spirit and the scope of the invention.

This application is based upon a Japanese patent application filed on Jan. 5, 2011 (Japanese Patent Application No. 2011-000600), the entire contents of which are incorporated herein by reference.

1. A method for treating organic wastewater in which organic wastewater is biologically treated and separated from biosludge by solid liquid separation using a separation membrane, and permeate water permeated through the separation membrane is subjected to reverse osmosis membrane separation treatment,
wherein the method comprises:
a solid liquid separation step for separating the biosludge by solid liquid separation with the separation membrane, and
a cleaning step of the separation membrane in which separating the biosludge is suspended, and the separation membrane is cleaned by passing a membrane cleaning liquid through the separation membrane from a permeate water side to a concentrated water side of the separation membrane,
wherein, at the beginning of the solid liquid separation step after the cleaning step, a pH of the permeate water through the separation membrane is adjusted to not less than 9.5, and a scale inhibitor is added to the permeate water, and the permeate water is thereafter treated by the reverse osmosis membrane separation treatment.

2. The method for treating organic wastewater according to claim 1, wherein the membrane cleaning liquid includes an oxidative cleaning agent and/or an acidic cleaning agent.

3. The method for treating organic wastewater according to claim 1, wherein the separation membrane is immersed in a biological reactor in which the wastewater is treated biologically.

4. An apparatus for treating organic wastewater comprising:
a biological treatment unit which biologically treats organic wastewater;
a membrane separation unit which separates biosludge in the biological treatment unit by solid liquid separation with a separation membrane; and
a reverse osmosis membrane separation unit which treats permeate water from the membrane separation unit by reverse osmosis membrane separation treatment,
wherein the apparatus further comprises:
a cleaning unit which cleans the separation membrane by passing a membrane cleaning liquid through the separation membrane of the membrane separation unit from a permeate water side to a concentrated water side thereof;
a pH adjusting unit which adjusts the permeate water from the membrane separation unit that is to be introduced into the reverse osmosis membrane separation unit to a pH of not less than 9.5; and
a scale inhibitor additing unit which adds a scale inhibitor to the permeate water.

5. The apparatus for treating organic wastewater according to claim 4, wherein the membrane cleaning liquid includes an oxidative cleaning agent and/or an acidic cleaning agent.

6. The apparatus for treating organic wastewater according to claim 4, wherein the separation membrane is immersed in a biological reactor of the biological treatment unit.
